(19) United States
(12) Patent Application Publication
(10) Pub. No.: US 2014/0342630 A1
(43) Pub. Date: Nov. 20, 2014

(54) WOVEN FABRIC PREFORMS AND PROCESS FOR MAKING THE SAME

(71) Applicant: MAGNA INTERNATIONAL INC., Aurora (CA)

(72) Inventors: Maximilian Amtmann, Brampton (CA); Boris Shulkin, West Bloomfield, MI (US); Aldo Van Gelder, Newmarket (CA); Judson Henderson Whiteside, Thornhill (CA); Todd Deaville, Markham (CA)

(21) Appl. No.: 14/372,070

(22) PCT Filed: Jan. 10, 2013
(86) PCT No.: PCT/CA2013/000018

§ 371 Date: Jul. 14, 2014

Related U.S. Application Data
(60) Provisional application No. 61/586,270, filed on Jan. 13, 2012.

(51) Int. Cl. D03D 13/00; D03D 15/00; B29C 70/02; D03D 25/00

(52) U.S. Cl. CPC D03D 13/004; D03D 25/005; D03D 15/0011; B29C 70/021; B29K 2277/00
USPC 442/203; 139/384 R; 139/420 C; 264/258

(57) ABSTRACT

Warps of a reinforcing filamentary yarn are selectively interwoven with wefts of the reinforcing filamentary yarn, so as to form a tailored woven reinforcement for use in the manufacture of a composite article having a known three-dimensional shape. The wefts extend in a direction transverse to said warps, to form at least one first portion of the woven reinforcement having interwoven warps and wefts, and to form at least one second portion of the woven reinforcement having other than interwoven warps and wefts. The at least one first portion and the at least one second portion are arranged, one relative to the other within said woven reinforcement, in dependence upon the known three-dimensional shape of the composite article. The woven reinforcement is suitable for use in a variety of processes including prepreg processes, Resin Transfer Molding processes and Resin Infusion Molding processes.

### CROSS REFERENCE TO RELATED APPLICATION

This PCT Patent Application claims the benefit of U.S. provisional application Ser. No. 61/586,270 filed Jan. 13, 2012, the entire disclosure of the application being considered part of the disclosure of this application, and hereby incorporated by reference.

### FIELD OF THE INVENTION

The instant invention relates generally to woven fabric preforms and to a process for making the same. More particularly, the instant invention relates to a process for producing tailored woven blanks for use in the manufacture of composite articles, and to the composite articles that are manufactured therefrom.

### BACKGROUND OF THE INVENTION

Composite materials are used routinely in the aerospace, automotive and sporting goods industries, to name just a few examples. Structural composite articles are lighter, offer better corrosion resistance, and display improved resistance to damage from cyclic loading (fatigue) compared to corresponding articles that are formed from machined metals. For instance, replacing an aluminum structure with graphite/epoxy composite may achieve a weight reduction of greater than 20%.

One common method of composite manufacture uses a pre-impregnated (prepreg) material made by applying a resin onto a reinforcement fiber. The resin, which is applied outside of a compression mold, may be a thermoplastic resin or a thermosetting resin applied onto a high tenacity reinforcement fiber. The fiber may be in the form of a non-woven fabric of short or long fiber length, or a woven or unidirectional fiber configuration of continuous fiber length. Typical reinforcing fibers include glass, carbon, aramid, basalt or another similar type of fiber. Alternatively, in the so-called Resin Transfer Molding or Resin Infusion Molding processes the reinforcement is placed into a mold and the thermoplastic or thermosetting resin is introduced after the mold is closed.

Reinforcing fibers in the form of woven fabrics exhibit excellent formability and result in composite articles with good mechanical properties. Woven fabrics are fabrics in which two distinct sets of reinforcing yarns or fibers are interwoven with each other to form the fabric. More specifically, woven fabrics include warp yarns that run lengthwise along the fabric and weft yarns that run across the length of the fabric, and which are interwoven with and generally perpendicular to the warp yarns. Typically, the size and density of the warps are equal to the size and density of the wefts, and the warps and the wefts cross each other at a right angle. Optionally, the warps and wefts are of different sizes and/or densities. Further optionally, different types of fiber are used for the warp yarns and for the weft yarns. Further optionally, the warps and wefts cross each other at other than a right angle.

A typical process for making a composite article based on prepreg material uses rectangular fabric blanks to build a preform, which is then wet out with resin and placed in a compression mold to form the finished composite article. In order to avoid wrinkling, binding, stretching or tearing, etc., the rectangular blanks are trimmed and layered up to optimize sheet usage. Additionally, the use of rectangular fabric blanks results in trimming being required around the entire perimeter of the finished composite article. It is therefore a disadvantage of the prior art process that the use of rectangular fabric blanks leads to a significant amount of wastage, of as much as 40% of the reinforcing fiber, since those portions of the blank that are trimmed do not wind up in the finished composite article. Further, the layering up of multiple plies and the trimming operations add to the process time and complexity, which results in overall higher costs for producing the composite articles.

It would be beneficial to provide a process that overcomes at least some of the above-mentioned limitations of the prior art.

### SUMMARY OF THE INVENTION

According to one aspect, the invention is directed to a process for fabricating a reinforcing woven fabric for use in the manufacture of a composite article having a known three-dimensional shape, comprising: arranging a plurality of warps of reinforcing filamentary yarns extending in a longitudinal direction of said reinforcing woven fabric in parallel to one another and in a sheet-like form; selectively interweaving a plurality of wefts of reinforcing filamentary yarns extending in a direction across said warps and in parallel to one another, so as to form at least one first portion of the woven fabric having interwoven warps and wefts and so as to form at least one second portion of the woven fabric having other than interwoven warps and wefts, wherein the at least one first portion and the at least one second portion are arranged one relative to the other within said reinforcing woven fabric in dependence upon the known three-dimensional shape of the composite article.

According to another aspect, the invention is directed to a process for fabricating a composite article having a known three-dimensional shape, comprising: forming a reinforcing woven fabric having a plurality of warps of reinforcing filamentary yarns extending in a longitudinal direction and having a plurality of wefts of reinforcing filamentary yarns selectively interwoven with said warps so as to form at least one first portion of the reinforcing woven fabric having interwoven warps and wefts and so as to form at least one second portion of the reinforcing woven fabric having other than interwoven warps and wefts; wetting the tailored reinforcing woven fabric with a resin; and applying heat and pressure to the resin-wetted tailored reinforcing woven fabric during a molding cycle in a mold to form the composite article.

According to another aspect, the invention is directed to a reinforcing woven fabric for use in the manufacture of a composite article having a known three-dimensional shape, comprising: a plurality of warps of reinforcing filamentary yarns extending in a longitudinal direction of said reinforcing woven fabric and in parallel to one another; and a plurality of wefts of reinforcing filamentary yarns extending in a direction across said warps and in parallel to one another, said plurality of wefts of reinforcing filamentary yarns being selectively interwoven with said plurality of warps of reinforcing filamentary yarns so as to form at least one first portion of the woven fabric having interwoven warps and wefts and so as to form at least one second portion of the woven fabric having other than interwoven warps and wefts, wherein the at least one first portion and the at least one second portion are arranged one relative to the other within said reinforcing woven fabric in dependence upon the known three-dimensional shape of the composite article.

According to another aspect, the invention is directed to a preformed material for use in the manufacture of a composite article having a known three-dimensional shape, said preformed material having a plurality of reinforcing woven fabrics laminated and integrated to each other, each of said plurality of reinforcing woven fabrics comprising: a plurality of warps of reinforcing filamentary yarns extending in a longitudinal direction of said reinforcing woven fabric and in parallel to one another; and a plurality of wefts of reinforcing filamentary yarns extending in a direction across said warps and in parallel to one another, said plurality of wefts of reinforcing filamentary yarns being selectively interwoven with said plurality of warps of reinforcing filamentary yarns so as to form at least one first portion of the woven fabric having interwoven warps and wefts and so as to form at least one second portion of the woven fabric having other than interwoven warps and wefts, wherein the at least one first portion and the at least one second portion are arranged one relative to the other within said reinforcing woven fabric in dependence upon the known three-dimensional shape of the composite article, and wherein the reinforcing woven fabrics of said plurality of reinforcing woven fabrics are so laminated that the at least one first portion of the respective reinforcing woven fabrics are conformed to each other and the at least one second portion of the respective reinforcing woven fabrics are conformed to each other

According to another aspect, the invention is directed to a fiber reinforced composite material including a preformed material comprising a plurality of woven fabrics laminated and integrated to each other and a resin containing said plurality of reinforcing woven fabrics, each of said plurality of reinforcing woven fabrics comprising: a plurality of warps of reinforcing filamentary yarns extending in a longitudinal direction of said reinforcing woven fabric and in parallel to one another; and a plurality of wefts of reinforcing filamentary yarns extending in a direction across said warps and in parallel to one another, said plurality of wefts of reinforcing filamentary yarns being selectively interwoven with said plurality of warps of reinforcing filamentary yarns so as to form at least one first portion of the woven fabric having interwoven warps and wefts and so as to form at least one second portion of the woven fabric having other than interwoven warps and wefts, wherein the at least one first portion and the at least one second portion are arranged one relative to the other within said reinforcing woven fabric in dependence upon the known three-dimensional shape of the composite article, and wherein the reinforcing woven fabrics of said plurality of reinforcing woven fabrics are so laminated that the at least one first portion of the respective reinforcing woven fabrics are conformed to each other and the at least one second portion of the respective reinforcing woven fabrics are conformed to each other.

According to another aspect, the invention is directed to a process for fabricating a plurality of blanks for use in the manufacture of composite articles, each blank of the plurality of blanks comprising interwoven reinforcing fibers, the process comprising: arranging a first plurality of warps of the reinforcing fibers extending in a longitudinal direction and in parallel to one another so as to define a carrier layer; interweaving a first plurality of wefts of the reinforcing fibers extending in a direction across said first plurality of warps and in parallel to one another so as to form a first interwoven region and a second interwoven region, the first interwoven region separated from the second interwoven region by a non-interwoven region of the carrier layer; and arranging a second plurality of warps of the reinforcing fibers adjacent to and overlapping with the first interwoven region, and interweaving a second plurality of wefts of the reinforcing fiber with the second plurality of warps, so as to define a plurality of first blanks stacked one on top of the other and connected together along opposite edge segments thereof.

According to another aspect, the invention is directed to a process for fabricating a plurality of blanks for use in the manufacture of composite articles, each blank comprising interwoven reinforcing fibers, the process comprising: interweaving reinforcing fibers that extend in a warp direction with reinforcing fibers that extend in a weft direction, to define: a plurality of first blanks stacked one on top of the other and connected together along opposite edge segments thereof; a plurality of second blanks stacked one on top of the other and connected together along opposite edge segments thereof; and a connecting web extending between the plurality of first blanks and the plurality of second blanks and comprising a single layer of reinforcing fibers.

According to another aspect, the invention is directed to a blank assembly comprising a plurality of blanks for use in the manufacture of composite articles, the blank assembly comprising: a plurality of first blanks stacked one on top of the other and connected together along opposite edge segments thereof, each of the plurality of first blanks comprising interwoven reinforcing fibers; a plurality of second blanks stacked one on top of the other and connected together along opposite edge segments thereof, each of the plurality of second blanks comprising interwoven reinforcing fibers; and a connecting web extending between the plurality of first blanks and the plurality of second blanks and comprising a single layer of reinforcing fibers.

### BRIEF DESCRIPTION OF THE DRAWINGS

The instant invention will now be described by way of example only, with reference to the attached drawings, in which:

FIG. 1 is a simplified diagram showing a system for the molding of composite articles using pre-impregnated tailored blanks, according to an embodiment of the instant invention;

FIG. 2 is a simplified diagram showing an example of a woven fabric blank, according to an embodiment of the instant invention;

FIG. 3 is a simplified diagram showing an example of another woven fabric blank, according to an embodiment of the instant invention;

FIG. 4 is a simplified flow diagram of a process for fabricating a reinforcing woven fabric for use in the manufacture of a composite article having a known three-dimensional shape;

FIG. 5 is a simplified flow diagram of a process for fabricating a composite article having a known three-dimensional shape;

FIG. 6a is a top view showing a woven fabric blank having regions in which plural layers of the blank are stacked one on top of another and said regions are joined together by a single layer of a carrier fiber;

FIG. 6b is a side view of the woven fabric blank of FIGS. 6a; and

FIG. 6c is a side view showing the plural layers of the blank of FIG. 6a subsequent to the plural layers being separated from the carrier fiber.

### DETAILED DESCRIPTION OF THE INVENTION

The following description is presented to enable a person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the scope of the invention. Thus, the present invention is not intended to be limited to the embodiments disclosed, but is to be accorded the widest scope consistent with the principles and features disclosed herein.

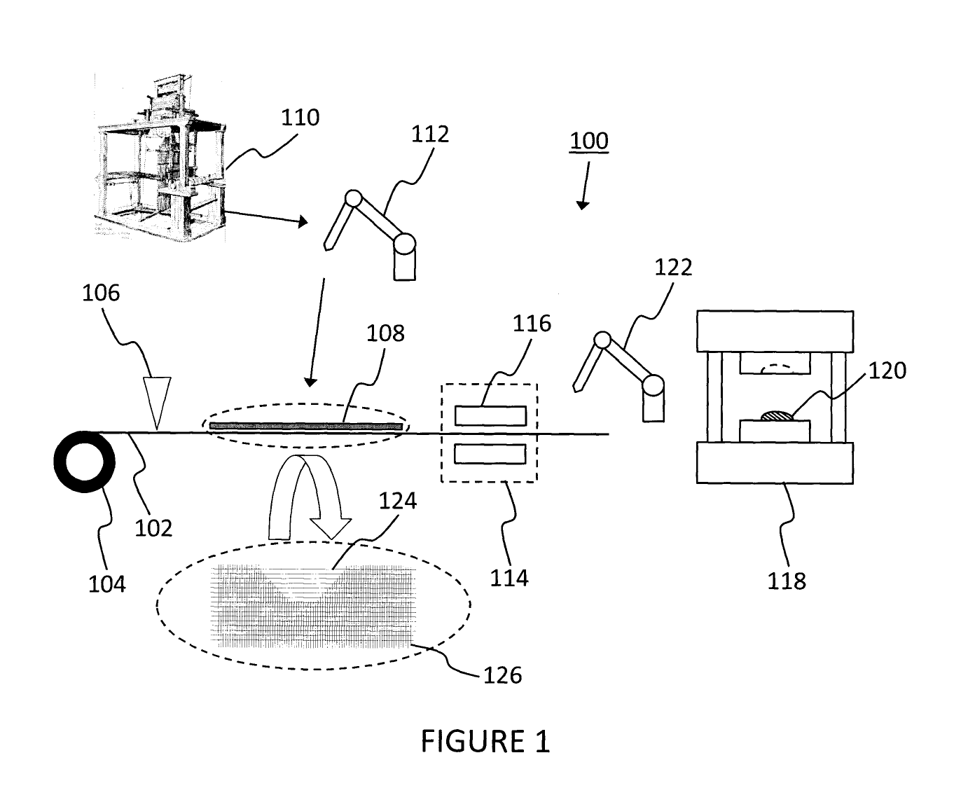

Referring to FIG. 1, shown is a simplified diagram of a system 100 for the molding of composite articles using pre-impregnated tailored blanks, according to an embodiment of the instant invention. In the specific and non-limiting example that is shown in FIG. 1, a carrier film 102 is unwound from carrier film unwind 104 and a resin is applied at resin applicator 106. Woven fabric reinforcement 108 is transferred from a loom 110 onto the carrier film 102, such as for instance using a robot 112, and is wet out with the resin in a conventional prepreg process. For instance, not illustrated rollers etc. are used to ensure proper wetting of the reinforcement 108 by the resin so as to form a prepreg to be used in the manufacture of the composite articles.

The prepreg so formed is advanced through a curing station 114, which includes an energy source 116 for providing the energy that is required to partially cure the prepreg. By way of a few specific and non-limiting examples, the energy source 116 is one of an oven and an ultraviolet radiation source. After being partially cured in the curing station 114, the prepreg is either stored for later use or it is transferred into a compression mold 118 and used to form a finished composite article 120. Prior to being placed in the compression mold 118, the prepreg is arranged on a not illustrated preforming mold such that a shape of the prepreg, when so arranged, corresponds approximately to a final shape of the composite article 120. The preformed prepreg is subsequently transferred from the preforming mold to the compression mold 118, for instance using robot 122, and heat and pressure are applied during a molding cycle so as to form the composite article 120. Once formed, the composite article 120 is removed from the compression mold 118, and the compression mold 118 is charged with a next preformed prepreg prior to beginning a next molding cycle. Excess material, if any, is trimmed from the composite article 120 using conventional techniques, such as for instance waterjet cutting, router, laser, knife, ultrasonic knife, etc.

When the prepreg is not to be stored for later use, but rather it is to be transferred directly into the compression mold 118, then optionally the step of partially curing the prepreg is omitted. In this case, the curing of the prepreg is performed entirely within the compression mold 118. As such, according to at least one embodiment of the invention the curing station 114 that is shown in FIG. 1 is optional.

Referring still to FIG. 1, the reinforcement 108 is shown within dashed ovals in both side and top views. The top view shows, by way of a specific and non-limiting example, a tailored shape of the reinforcement 108. More particularly, the warps of reinforcing fiber 124 are provided to the loom 110 as a carrier layer, such that the individual warps 124 extend lengthwise along the length of the reinforcement 108. Further, the warps 124 are arranged substantially parallel one with respect to the other in a direction that is along the length of the reinforcement. The warps 124 are held, under tension, by the loom 110 during fabrication of the reinforcement 108. Wefts 126 are interwoven with the warps 124 only where required by the part geometry of the finished composite article 120. For instance, based on the known three-dimensional shape of the finished composite article 120 a back-calculation is performed, in order to determine which portions of the reinforcement 108 need to be built up by weaving in the wefts 126. In this way, the reinforcement 108 that is produced using loom 110 is tailored for the particular shape of the finished composite article. Optionally, predetermined portions of the reinforcement 108 are built up locally with plural layers or plies of the reinforcing fibers, so as to provide reinforced areas within the finished composite article. Of course, the reinforcement 108 that is shown in FIG. 1 is intended to be illustrative in nature and the spacing between the individual warps and wefts is greatly exaggerated for improved clarity. In practice, the warps and wefts of the reinforcing fiber may be interwoven closely together.

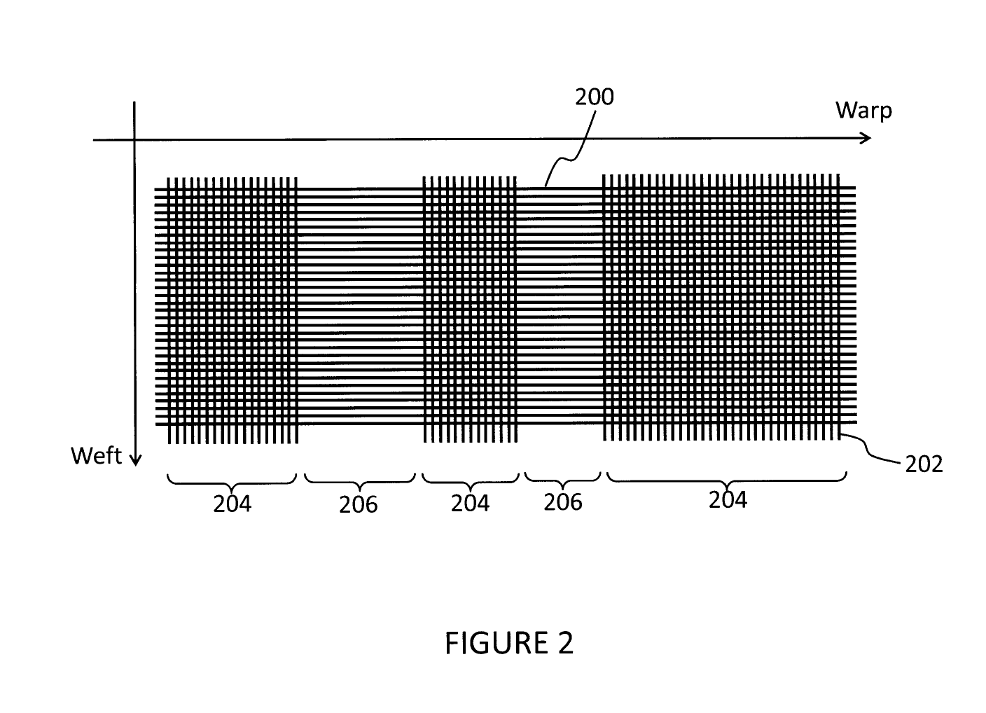

Referring now to FIG. 2, shown is an example of a tailored woven fabric blank for use in making a preform for a composite article. As is shown in FIG. 2, warps of reinforcing fiber 200 extend along the length of the woven fabric blank in the “Warp” direction, and wefts of reinforcing fiber 202 extend transverse to the warps 200 in the “Weft” direction. The woven fabric blank is tailored based on the part geometry of the finished composite article. In this case, wefts 202 are interwoven with warps 200 within first portions 204 of the woven fabric blank. The warps 200 within second portions 206 of the woven fabric blank do not have wefts 202 interwoven therewith. As discussed above, for instance, based on the known three-dimensional shape of the finished composite article a back-calculation is performed. In particular, the back calculation is performed in order to determine the first portions 204 of the woven fabric blank that are to be built up by weaving in the wefts 202 as well as the second portions 206 of the woven fabric blank that are not to be built up. Optionally, the first portions 204 are built up with a single layer or with plural layers of the reinforcing fiber. When the first portions 204 are built up with plural layers, then multiple plies of the reinforcement are fabricated directly into a single blank. Further optionally, different ones of the first portions 204 are built up with a different number of layers of the reinforcing fiber. As was discussed above, the spacing between the individual warps and wefts is greatly exaggerated for improved clarity.

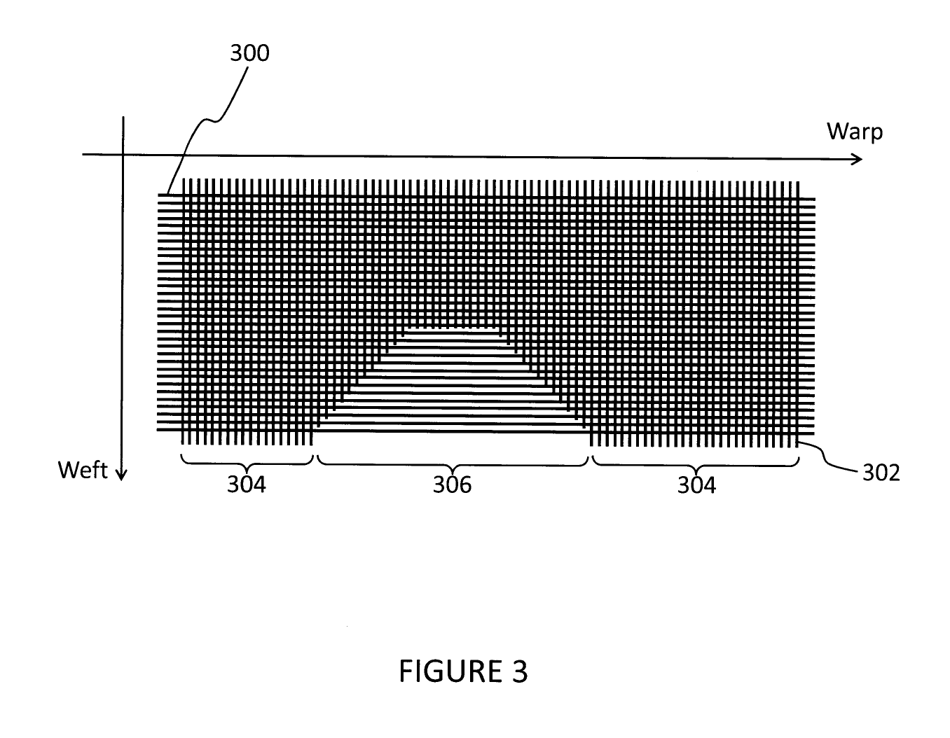

Referring now to FIG. 3, shown is another example of a tailored woven fabric blank for use in making a preform for a composite article. As is shown in FIG. 3, warps of reinforcing fiber 300 extend along the length of the woven fabric blank in the “Warp” direction, and wefts of reinforcing fiber 302 extend transverse to and are interwoven with the warps 300 in the “Weft” direction. The woven fabric blank is tailored based on the part geometry of the finished composite article. In this example, wefts 302 are interwoven with warps 300 within first portions 304 as well as within a second portion 306 of the woven fabric blank. Within the first portions 304, the wefts 302 extend in the weft direction between opposite lateral edges of the woven fabric blank. On the other hand, within the second portion 306 the wefts 302 extend only part way between the opposite lateral edges of the woven fabric blank. In particular, the wefts 302 within the second portion 306 terminate at points that are determined based on the known three-dimensional shape of the finished composite article. For instance, as is discussed above, a back-calculation is performed based on the known three-dimensional shape of the finished composite article, so as to determine the placement of the wefts 302 within the second portion 306. As was discussed above, the spacing between the individual warps and wefts is greatly exaggerated for improved clarity.

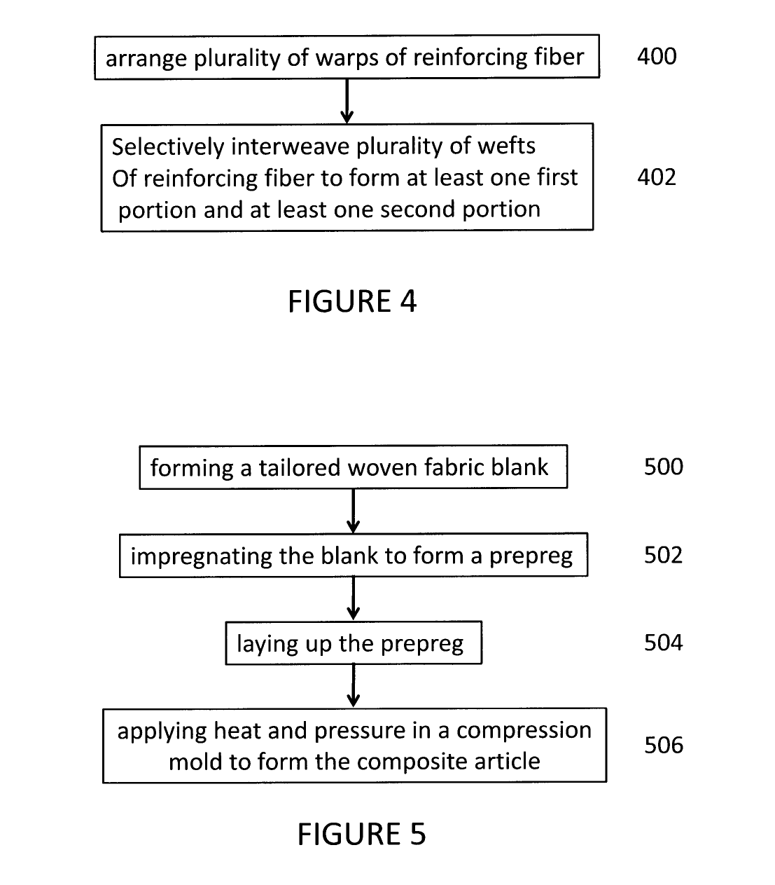

Referring now to FIG. 4, shown is a simplified flow diagram of a process for fabricating a reinforcing woven fabric for use in the manufacture of a composite article having a known three-dimensional shape. At 400 a plurality of warps of reinforcing filamentary yarns (reinforcing fibers) are arranged so as to extend in a longitudinal direction of said reinforcing woven fabric. For instance, the warps are held under tension by a loom, parallel to one another and in a sheet-like form. At 402 a plurality of wefts of reinforcing filamentary yarns (reinforcing fibers) is selectively interwoven with the warps. The wefts are arranged in a direction across said warps, and in parallel to one another so as to form at least one first portion of the woven fabric having interwoven warps and wefts and so as to form at least one second portion of the woven fabric having other than interwoven warps and wefts. The at least one first portion and the at least one second portion are arranged one relative to the other within said reinforcing woven fabric in dependence upon the known three-dimensional shape of the composite article. The warps and the wefts are selectively interwoven such that only the warps extend through the at least one second portion. The reinforcing woven fabric may be impregnated with a resin to form a prepreg, and the resulting prepreg may be arranged on a performing mold such that it has a shape, when so arranged, corresponding approximately to the known three-dimensional shape of the composite article.

Referring now to FIG. 5, shown is a simplified flow diagram of a process for fabricating a composite article having a known three-dimensional shape. At 500 a reinforcing woven fabric is formed, the reinforcing woven fabric having a plurality of warps of reinforcing filamentary yarns (reinforcing fibers) that extend in a longitudinal direction and having a plurality of wefts of reinforcing filamentary yarns (reinforcing fibers) selectively interwoven with said warps. In this way, the reinforcing woven fabric is formed with at least one first portion having interwoven warps and wefts and with at least one second portion of the reinforcing woven fabric having other than interwoven warps and wefts. For instance, the reinforcing woven fabric is formed according to the process that is described above with reference to FIG. 4. At 502 the tailored reinforcing woven fabric is impregnated with a resin to form a prepreg. At 504 the prepreg is arranged on a form having substantially the shape of the composite article. At 506 heat and pressure are applied to the prepreg during a molding cycle in a compression mold to form the composite article. Subsequent to molding, the composite article is trimmed as required.

The system that is shown in FIG. 1, the woven fabric blanks illustrated in FIGS.

2 and 3, and the processes that are described with reference to FIGS. 4 and 5 have all been discussed in general terms, in order to provide a clear understanding of the various embodiments of the instant invention. The system, blanks and processes are all suitable for use with a wide variety of thermosetting resins and reinforcing fiber types. For instance, the resin is a thermosetting resin that is optionally selected from the following group: epoxy, vinyl ester, polyester, polyurethane, or another suitable thermosetting resin. Similarly, the reinforcing fiber that is woven together to form the blank is optionally selected from the following group: glass fibers, carbon fibers, aramid fibers, basalt fibers, or another suitable type of fiber.

According to one optional variation, the prepreg that is formed is a thermoplastic prepreg. According to another optional variation, prepreg material is not formed but rather the woven reinforcement is produced and transferred into a mold prior to being wetted with the resin. In this latter case, the resin is introduced into the closed compression mold and Resin Transfer Molding or Resin Infusion Molding is used to produce the composite article.

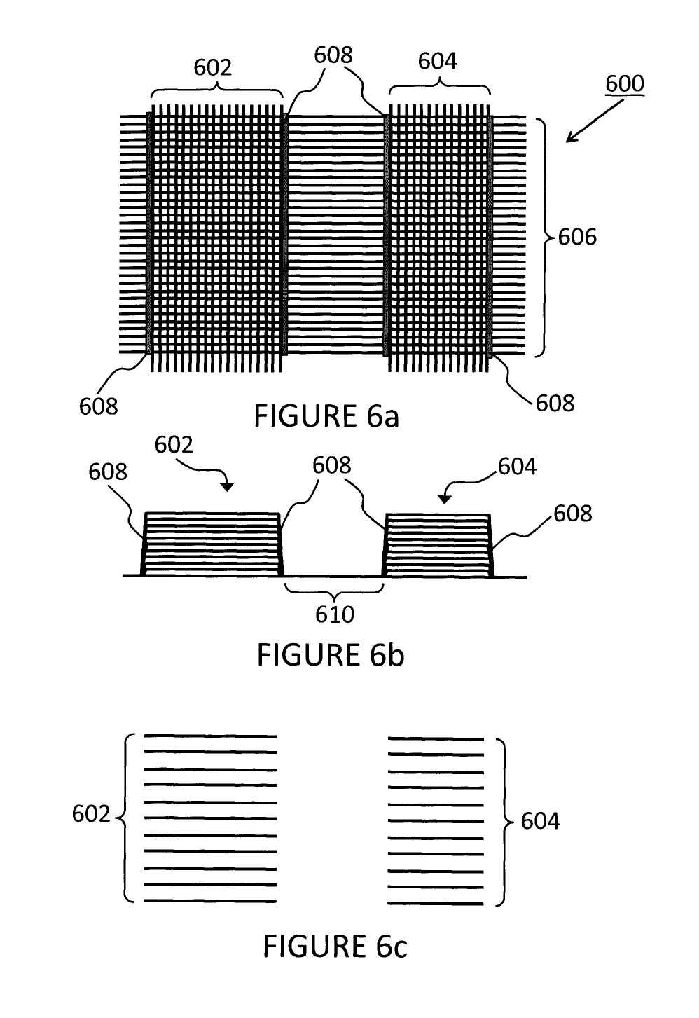

In the description that is presented above, the loom 110 is used to produce tailored woven reinforcements having locally built up reinforced regions and/or an arrangement of woven and non-woven areas that is suitable for forming a composite article with a known three-dimensional shape. Alternatively, the tailored woven reinforcement is produced in such a way that plural layers of a same part-shape are formed one on top of another. FIG. 6a is a top view of a woven reinforcement blank assembly 600 having plural stacked layers of a first shape 602 and plural stacked layers of a second shape 604. Referring also to FIG. 6b, shown is a side view of the plural layers of the first and second shapes, 602 and 604, respectively, connected to a carrier layer 606 via end-stitching 608 that is formed along edge segments of the plural layers. FIG. 6c is a side view showing the plural layers of the first and second shapes, 602 and 604, respectively, subsequent to the plural layers being separated one from another. The plural layers are separated one from the other such as by cutting through the end-stitching 608. Since the plural layers of the first shape 602 and the plural layers of the second shape 604 are connected together via a region 610 that has only a single layer of the reinforcing fibers, a substantial reduction of fiber wastage is achieved.

The blank assembly 600 comprises a plurality of first blanks, each first blank of the plurality of first blanks being one of the layers of the first shape 602. The first blanks of the plurality of first blanks are stacked one on top of the other and are connected together along opposite edge segments thereof via end-stitching 608. The blank assembly 600 further comprises a plurality of second blanks, each second blank of the plurality of second blanks being one of the layers of the second shape 604. The second blanks of the plurality of second blanks are also stacked one on top of the other and are also connected together along edge segments thereof via end-stitching 608. Each first blank and each second blank comprises interwoven reinforcing fibers. A connecting web 610 extending between the plurality of first blanks and the plurality of second blanks comprises a single layer of reinforcing fibers. The connecting web 610 is a part of a sheet-like carrier layer, which comprises a plurality of warps of reinforcing fiber extending in a longitudinal direction and parallel to one another. The reinforcing fibers are selected from the following group: glass fibers, carbon fibers, aramid fibers, basalt fibers, or another suitable type of fiber.

As is shown in FIG. 6b, one first blank of the plurality of first blanks and one second blank of the plurality of second blanks is formed within the carrier layer, by selectively interweaving a plurality of wefts of reinforcing fiber with the plurality of warps of reinforcing fiber. In this way, the warps and wefts are selectively interwoven so as to form a first interwoven region of the carrier layer corresponding to the one of the plurality of first blanks and to form a second interwoven region of the carrier layer corresponding to the one of the plurality of second blanks. The connecting web is a non-interwoven region of the carrier layer.

While the above description constitutes a plurality of embodiments of the present invention, it will be appreciated that the present invention is susceptible to further modification and change without departing from the fair meaning of the accompanying claims.

1-6. (canceled)

7. A process for fabricating a composite article having a known three-dimensional shape, comprising:
forming a reinforcing woven fabric having, a plurality of warps of reinforcing filamentary yarns extending in a longitudinal direction and having a plurality of wefts of reinforcing filamentary yarns selectively interwoven with said warps so as to form at least one first portion of the reinforcing woven fabric having interwoven warps and wefts and so as to form at least one second portion of the reinforcing woven fabric having other than interwoven warps and wefts;
wetting the tailored reinforcing woven fabric with a resin; and
applying heat and pressure to the resin-wetted, tailored reinforcing woven fabric during a molding cycle in a mold to form the composite article.

8. The process of claim 7 wherein wetting with the resin is performed prior to transferring the tailored reinforcing woven fabric into the mold, so as to form a prepreg.

9. The process of claim 8 comprising, prior to transferring the prepreg into the mold, laying up the prepreg on a preform having substantially the shape of the composite article.

10. The process of claim 7 wherein wetting with the resin is performed subsequent to transferring the tailored reinforcing woven fabric into the mold.

11. The process of claim 7 wherein the resin is one a thermosetting resin and a thermoplastic resin.

12. (canceled)

13. The process of claim 7 comprising performing a back-calculation to determine the at least one first portion and the at least one second portion based on the known three-dimensional shape of the composite article.

14. The process of claim 7 wherein the wefts of reinforcing filamentary yarns other than extend through the at least one second portion.

15. The process of claim 7 wherein the wefts of reinforcing filamentary yarns extend along a direction that is approximately normal to the warps of reinforcing filamentary yarns.

16. The process of claim 7 wherein the reinforcing filamentary yarns comprise fibers selected from the group consisting of glass fibers, carbon fibers, basalt fibers and aramid fibers.

17. The process of claim 7 comprising providing a plurality of plies of the interwoven warps and wefts within a predetermined region of the at least one first portion of the woven fabric, for providing a predetermined region of local reinforcement within the composite article.

18. A reinforcing woven fabric for use in the in manufacture of a composite article having a known three-dimensional shape, comprising:
a plurality of warps of reinforcing filamentary yarns extending in a longitudinal direction of said reinforcing woven fabric and in parallel to one another; and
a plurality of wefts of reinforcing filamentary yarns extending in a direction across said warps and in parallel to one another, said plurality of wefts of reinforcing filamentary yarns being selectively interwoven with said plurality of warps of reinforcing filamentary yarns so as to form at least one first portion of the woven fabric having interwoven warps and wefts and so as to form at least one second portion of the woven fabric having other than interwoven warps and wefts,
wherein the at least one first portion and the at least one second portion are arranged one relative to the other within said reinforcing woven fabric in dependence upon the known three-dimensional shape of the composite article.

19. The reinforcing woven fabric of claim 18 wherein the arrangement of the at least one first portion relative to the at least one second portion is determined in dependence upon a back-calculation based on the known three-dimensional shape of the composite article.

20. The reinforcing woven fabric of claim 18 wherein the wefts of reinforcing filamentary yarns other than extend through the at least one second portion.

21. The reinforcing woven fabric of claim 18 wherein the wefts of reinforcing filamentary yarns extend along a direction that is approximately normal to the warps of reinforcing filamentary yarns.

22. The reinforcing woven fabric of claim 18 wherein the reinforcing filamentary yarns comprise fibers selected from the group consisting of glass fibers, carbon fibers, basalt fibers and aramid fibers.

23. The reinforcing woven fabric of claim 18 wherein a predetermined region of the at least one first portion of the woven fabric comprises to plurality of plies of the interwoven warps and wefts, for providing a predetermined region of local reinforcement within the composite article.

24. A preformed material for use in the manufacture of a composite article having a known three-dimensional shape, said preformed material having a plurality of reinforcing woven fabrics laminated and integrated to each other, each of said plurality of reinforcing woven fabrics comprising:
a plurality of warps of reinforcing filamentary yarns extending in a longitudinal direction of said reinforcing woven fabric and in parallel to one another; and
a plurality of wefts of reinforcing filamentary yarns extending in a direction across said warps and in parallel to one another, said plurality of wefts of reinforcing filamentary yarns being selectively interwoven with said plurality of warps of reinforcing filamentary yarns so as to form at least one first portion of the woven fabric having interwoven warps and wefts and so as to form at least one second portion of the woven fabric having other than interwoven warps and wefts,
wherein the at least one first portion and the at least one second portion are arranged one relative to the other within said reinforcing woven fabric in dependence upon the known three-dimensional shape of the composite article, and
wherein the reinforcing woven fabrics of said plurality of reinforcing woven fabrics are so laminated that the at least one first portion of the respective reinforcing woven fabrics are conformed to each other and the at least one second portion of the respective reinforcing woven fabrics are conformed to each other.

25. The preformed material of claim 24 wherein the arrangement of the at least one first portion relative to the at least one second portion is determined in dependence upon to back-calculation based on the known three-dimensional shape of the composite article.

26. The preformed material of claim 24 wherein the wefts of reinforcing filamentary yarns other than extend through the at least one second portion.

27. The preformed material of claim 24 wherein the wefts of reinforcing filamentary yarns extend along a direction that is approximately normal to the warps of reinforcing filamentary yarns.

28. The preformed material of claim 24 wherein the reinforcing filamentary yarns comprise fibers selected from the group consisting of glass fibers, carbon fibers, basalt fibers and aramid fibers.

29-49. (canceled)

50. The preformed material of claim 24, further comprising a resin containing said plurality of reinforcing woven fabrics.

51. The preformed material of claim 50, wherein the resin is one of a thermosetting resin and a thermoplastic resin.
